(19) United States
(12) Patent Application Publication
(10) Pub. No.: US 2023/0394582 A1
(43) Pub. Date: Dec. 7, 2023

(54) USER INTERFACE FOR GUIDING ACTIONS FOR DESIRED IMPACT

(71) Applicant: Foreside Financial Group, LLC, Portland, ME (US)

(72) Inventor: LUKE WILCOX, Minneapolis, MN (US)

(73) Assignee: Foreside Financial Group, LLC, Portland, ME (US)

(21) Appl. No.: 18/321,194

(22) Filed: May 22, 2023

Related U.S. Application Data
(60) Provisional application No. 63/344,156, filed on May 20, 2022.

(51) Int. Cl. G06Q 40/06; G06Q 30/0601

(52) U.S. Cl. CPC G06Q 40/06; G06Q 30/0631

(57) ABSTRACT

The concept involves systems and methods for a user to see how they can manage their particular investment based on a Persona. The Persona is based on a survey taken by the user and provides ratings of companies, funds, and portfolios that align with the unique persona. Each Persona has an ever-growing set of information that distinguishes it from other Personas, including the specific mix of causes, descriptive information about the Persona, top-rated companies and investments, and other organizations supporting the Persona's causes. Personas can be used to present details on the specific causes the user supports. Personas generate ratings of companies, funds, and portfolios particular to each Persona, provide visual reporting about the impact of the user's portfolio on their Persona, and create a community with other users with the same or similar Persona(s).

### CROSS-REFERENCE TO RELATED APPLICATIONS

This application claims priority to U.S. provisional patent application Ser. No. 63/344,156, filed on May 20, 2022; which is herein incorporated by reference in its entirety.

### BACKGROUND

Most investors lack information regarding how their investments are impacting the social, the political, the ecological, and/or the economic world. For those investors who want to know these details in order to make informed investment decisions about the impact their potential investment and purchasing decisions make, investors might need to manually search for and gather information and even then, the investors are left to make certain guesses based on either too little information or be overwhelmed with too much information to digest. Examples of information may include, for example, controversies in the media, reports, white papers, social media postings, etc. It can be nearly impossible for an investor to understand the actual impact their investments are making in the world. Further, for those investors who make investments to make a particular (or predetermined) impact in the social, the political, the ecological, and/or the economic world, it has been nearly impossible to understand the real impact being made by those investments.

### SUMMARY

Following summary is a high-level overview of various aspects and introduces some of the concepts that are further described in the Detailed Description section below. This summary is not to be used in isolation to determine the scope of the claimed subject matter. The subject matter should be understood by reference to appropriate portions of the entire specification, any or all drawings, and each claim.

Embodiments of the disclosure are directed to personalizing ratings based on an impact assessment. According to some embodiments, systems and methods for generating personalizing ratings comprise obtaining one or more impact assessment(s), wherein each of the one or more impact assessment(s) includes logical groupings that are based on a set of criteria, such as for example, individual preferences (social, economic, and/or political) and/or group identification(s).

In some aspects, the techniques described herein relate to a computer device, including: a processor; and a display device in communication with the processor, wherein the display device displays a user interface, the user interface includes a set of impact assessment inquiries, and an input interface for receiving user input, wherein the user input includes a set of assessment data based on the set of impact assessment inquiries; the processor, upon receipt of the user input, receives the set of assessment data; the processor generates an organized assessment data from the set of assessment data; the processor determines a Persona based on the organized assessment data; and the Persona is displayed on the user interface.

In some aspects, the techniques described herein relate to a computer device, wherein the processor: obtains a metric data about a company, fund, and/or investment vehicle; creates normalized metric score about the company, fund, and/or investment vehicle from the metric data; maps the normalized metric score to a cause, creates a cause score for the company, fund, and/or investment vehicle; maps the cause score to the Persona; determine a Persona Rating for the company, fund, and/or investment vehicle; and displays in the user interface, the cause score to the Persona and/or the Persona Rating.

In some aspects, the techniques described herein relate to a computer device, wherein the processor: determines a real-world impact metric for a benchmark based on the Persona Rating; and displays in the user interface, the real-world impact metric for the benchmark.

According to aspects of the present disclosure, a computer system for personalizing ratings based on an impact assessment comprising one or more processors; and non-transitory computer-readable storage media encoding instructions which, when executed by the one or more processors, causes the computer system to: gather relevant data to a Persona; organize relevant data into a metric; normalize metric data into a company score; create normalized metric scores for a fund based on holdings; map the metric data to a cause; wherein a first weight is assigned for each metric data; create a cause score for a company in a database; map the cause score to the Persona, wherein a second weight is assigned for each cause score; create a Persona Rating for the company and the fund in the database; create a dynamic Persona Rating of portfolios based on holdings; create one or more analyses relevant to the persona based on the relevant data; update the relevant data; and provide a user interface programmed to display generated reports and customized information regarding the persona of the impact assessment.

In some aspects, the techniques described herein relate to a computer system for determining a Persona based on an impact assessment, including: one or more processors; a display device in communication with the one or more processors; and non-transitory computer-readable storage media encoding instructions which, when executed by the one or more processors, causes the computer system to: display on the display device, a user interface which is configured to: display a set of impact assessment inquiries, and an interface for inputting a set of assessment data based on the set of impact assessment inquiries; via the one or more processors, receive the set of assessment data; via the one or more processors, generate an organized assessment data from the set of assessment data; via the one or more processors, determine a Persona based on the organized assessment data; and display the Persona in the user interface of the display device.

In some aspects, the techniques described herein relate to a computer system, wherein the encoding instructions when executed by the one or more processors, further causes the computer system to: via the one or more processors, obtain a metric data about a company, fund, and/or investment vehicle; create normalized metric score about the company, fund, and/or investment vehicle from the metric data; map the normalized metric score to a cause, wherein a weight is assigned for each of the metric data; create a cause score for the company, fund, and/or investment vehicle; map the cause score to the Persona; determine a Persona Rating for the company, fund, and/or investment vehicle; and display in the user interface of the display device, the cause score to the Persona and/or the Persona Rating.

In some aspects, the techniques described herein relate to a computer system, wherein the normalized metric score is determined by the following formula:

normalized metric score=50+(16.667×Z_{company}).

The Z_{company} being a standard score for a company for a particular cause.

In some aspects, the techniques described herein relate to a computer system, wherein at least one of the one or more processors is a part of a server device; and the display device is connected to a client device in communication with the server device via a network.

In some aspects, the techniques described herein relate to a computer system, wherein the encoding instructions when executed by the one or more processors, further causes the computer system to: via the one or more processors, determine a real-world impact metric for a benchmark based on the Persona Rating; and display in the user interface of the display device, the real-world impact metric for the benchmark.

In some aspects, the techniques described herein relate to a computer system, wherein the real-world impact metric is determined from the following formula:

real-world impact metric=(Vᵢₙᵥₑₛₜₘₑₙₜ÷R_{cost})×e.

The Vᵢₙᵥₑₛₜₘₑₙₜ being a value of the company, fund, and/or investment vehicle, and the R_{cost} being a real-world cost of a single unit, and wherein the e is an efficiency relative to the benchmark.

In some aspects, the techniques described herein relate to a computer system, wherein at least one of the one or more processors is a part of a server device; and the display device is connected to a client device in communication with the server device via a network.

In some aspects, the techniques described herein relate to a method for determining a Persona based on an impact assessment, including: displaying on a display device of a client device via one or more processors, a user interface which is configured to: display a set of impact assessment inquiries, and an interface for inputting a set of assessment data based on the set of impact assessment inquiries; receiving, via the one or more processors, the set of assessment data; generating, via the one or more processors, an organized assessment data from the set of assessment data; determining, via the one or more processors, the Persona based on the organized assessment data; storing the Persona on a non-transitory computer-readable storage media; and displaying the Persona in the user interface of the display device.

In some aspects, the techniques described herein relate to a method, further including: obtaining, via the one or more processors, a metric data about a company, fund, and/or investment vehicle; creating, via the one or mor processors, a normalized metric score about the company, fund, and/or investment vehicle from the metric data; mapping, via the one or more processors, the normalized metric score to a cause, wherein a weight is assigned for each of the metric data; creating, via the one or more processors, a cause score for the company, fund, and/or investment vehicle; storing the cause score on the non-transitory computer-readable storage media; mapping, via the one or more processors, the cause score to the Persona; determining, via the one or more processors, a Persona Rating for the company, fund, and/or investment vehicle; and storing the Persona Rating on the non-transitory computer-readable storage media; and displaying in the user interface of the display device, the cause score to the Persona and/or the Persona Rating.

In some aspects, the techniques described herein relate to a method, wherein the creating the normalized metric score uses the following formula:

normalized metric score=50+(16.667×Z_{company}).

The Z_{company} being a standard score for a company for a particular cause.

In some aspects, the techniques described herein relate to a method, further including: determining, via the one or more processors, a real-world impact metric for a benchmark based on the Persona Rating; and displaying in the user interface of the display device, the real-world impact metric for the benchmark.

In some aspects, the techniques described herein relate to a method, wherein the determining the real-world impact metric uses the following formula:

real-world impact metric=(Vᵢₙᵥₑₛₜₘₑₙₜ÷R_{cost})×e.

The Vᵢₙᵥₑₛₜₘₑₙₜ being a value of the company, fund, and/or investment vehicle, and the R_{cost} being a real-world cost of a single unit, and wherein the e is an efficiency relative to the benchmark.

The details of one or more techniques are set forth in the accompanying drawings and the description below. Other features, objects, and advantages of these techniques will be apparent from the description, drawings, and claims.

### DESCRIPTION OF THE DRAWINGS

References are made to the accompanying drawings that form a part of this disclosure and that illustrate embodiments in which the systems and methods described in this Specification can be practiced. Like reference numbers represent the same or similar parts throughout.

FIG. 1 shows a schematic drawing of a system according to some embodiments.

FIG. 2 shows an exemplary process implemented by an exemplary system, according to some embodiments.

FIG. 3 shows an exemplary schematic user interface for selecting one or more cause categories, according to some embodiments.

FIG. 4 shows an exemplary schematic user interface for ranking cause categories, according to some embodiments.

FIG. 5 shows an exemplary user interface for rating the importance of cause subcategories, according to some embodiments.

FIG. 6 shows an exemplary schematic user interface for visually displaying the assigned persona, according to some embodiments.

FIG. 7 shows exemplary user interface for visually displaying the assigned persona, according to some embodiments.

FIG. 8 shows an exemplary schematic user interface for visually displaying impact ratings for the assigned persona, according to some embodiments.

FIG. 9 shows an exemplary user interface for displaying the detailed analyses and reporting for various personas, according to some embodiments.

FIG. 10 shows an exemplary user interface for visually displaying the real-world impact metrics for selected benchmarks, according to some embodiments.

FIG. 11 shows an exemplary schematic user interface for researching various companies and investment funds for better-aligned personas, according to some embodiments.

FIG. 12 shows an exemplary schematic user interface for visually displaying impact metrics of an example company, according to some embodiments.

FIG. 13 shows an exemplary schematic user interface for visually displaying impact metrics of an example company, according to some embodiments.

FIG. 14 shows example schematic components of a server device, according to some embodiments.

### DETAILED DESCRIPTION

Among those benefits and improvements that have been disclosed, other objects and advantages of this disclosure will become apparent from the following description taken in conjunction with the accompanying figures. Detailed embodiments of the present disclosure are disclosed herein; however, it is to be understood that the disclosed embodiments are merely illustrative of the disclosure that may be embodied in various forms. In addition, each of the examples given regarding the various embodiments of the disclosure which are intended to be illustrative, and not restrictive.

Embodiments of the systems and methods disclosed herein are directed towards providing a user to understand how their investments are impacting the social, the political, the ecological, and/or the economic world.

Further, embodiments of the systems and methods disclosed herein provide strategic information about investments to users such that those investments lead to making a particular (or predetermined) impact in the social, the political, the ecological, and/or the economic world.

The embodiments of the disclosure use a method of quantifying the impact via an Impact Determination.

The embodiments of the disclosure use a method of quantifying various interests to create a digital identify called a Persona for the user. The term Persona is used herein to mean a digital identity which represents a user's interests, beliefs, and/or goals, which can be determined by the embodiments in the disclosure.

Further, a Persona Rating is a quantified value determined for any one or more entities, funds, investment vehicles, etc. for the Persona (e.g., the interests and/or goals, such as, for example, particular social, political, ecological, and/or economic issue(s)).

Some of the embodiments of the disclosure are directed toward improving user interaction with a computer device and/or system, wherein a user interface is provided and displayed on a display device to control the computer device and/or system. According to some embodiments, the improved user interface for a computer device provides information and/or analytics which was not possible, wherein a user can interact with the user interface to improve alignment of the user's Persona with the user's actions (e.g., investment strategy). Further, the improved user interface can provide and display a real-world impact the user is making or can make based on the user's actions.

The embodiments of the disclosure achieve a technical effect on a process which is carried outside of the computer. The technical effect is providing strategic information via a technological specialized computer device and/or system to achieve an effect that is external to the computer device, wherein the effect is changing (e.g., improving) a particular social, political, ecological, and/or economic issue(s) that can be affected by the user's investment based on the strategic information.

The embodiments of the disclosure can achieve results in a specialized computing device and/or system what is being made to operate in a new way. the specialized computing device and/or system is made to quantify information which could not have been quantified in this manner, to provide new information in a simple to understand manner via a specialized user interface. That is, the embodiments of the methods, devices, and systems of the disclosure provide a computing technology which is made to operate in a novel way to deliver a tangible and useful information which could not have been possible without the embodiments of the disclosure.

The embodiments of the disclosure can achieve results of the computer device and/or system processing data and information to provide results faster and more efficiently. Without the embodiments of the disclosure, there was no way of quantifying how various investments were impacting the world. In order to do so manually, or by using a general computer, the process would have taken too long for such process to have been useful, as information about investments change so quickly. However, the various embodiments of the disclosure provides the technological and means of processing data and information quickly (e.g., in real time or substantially real time) to provide quantified information on how various investments are or can impact the world. Accordingly, for those investors who want to invest to make a particular (or predetermined) impact, what was impossible has been made possible. That is, the investors can use the embodiments of the disclosure to understand the real world impact being made by their investments.

This disclosure relates to quantifying investment data and/or information to determine a real world impact, or Impact Determination, being made by the investment data and/or information.

In the examples provided herein, the system provides a unique configuration for an automated collection and integration of large amounts of data, which is subsequently analyzed to generate personalized ratings (e.g., converted to quantified data) based on predetermined preferences (e.g., preferences set by a user) for having a desired (or predetermined) impact (which can be a real world impact or Impact Determination).

The system can create quantified reports about investments, purchasing, and/or portfolio impact, while also providing transparent access to the underlying raw data supporting the Impact Determination.

Users (e.g., investors) can better use and understand data when the data is sourced credibly. Because the system transparently presents all underlying data in a user interface that is easily digestible, investors can trust and receive personalized impact personas that generate investment recommendations based on a user's preferences. The system can integrate with asset management systems and services. For example, environmental, social, and/or governance (ESG) focused mutual and custom portfolios or separately managed accounts (SMAs). The system can be used to develop further analyses for users and integrate with online investment brokerages and shopping experiences.

Embodiments of the systems and methods achieves an improvement over the typical, manual process that investors might attempt to use to understand the impact or “values-alignment” of their investment and purchase decisions because the conventional process involves manually searching for one-off data points, such as information about controversies in the media. The embodiments solves the issues of difficulty accessing credible information about the true impact of a company, brand, fund, and/or portfolio, lack of transparency of data, and the costliness of accessing data. For example, accessing and aggregating such data from various data sources would require immense computer resources and power. For example, some embodiments can efficiently and quickly process and generates an ESG impact model that reduces redundant computing efforts and provides data sources and credibility transparency.

Examples of users can include investors, financial advisor firms, wealth management firms, asset management firms, consumers, and clients. The system generates the ESG impact model that includes data algorithms and analyses that seek to organize and present the true impact of an investment on an ESG cause or set of causes, such as climate action, gender equality, mental health, etc.

For example, the ESG impact model considers the impact of any given company's actions, business model, and decisions on a cause that the user might care about. The ESG impact model allows users to select and rate the importance of specific causes, and algorithms are employed to choose the most appropriate weighted-average ratings and analyses for that specified set of causes. Furthermore, the ESG impact model offers an improved method of aggregating disparate types of information into meaningful insights for users and company self-reported data and government data. The ESG impact model considers and combines over forty metrics from non-governmental organizations to better assess the true impact of a company, fund, or portfolio on ESG causes.

The system employs impact Personas which are archetypes of ethical causes that users may want to consider. Impact Personas are weighted collections of causes that, when taken together, have more meaning and utility than the user causes by themselves. Placing an individual user in a larger group of like-minded users and building community around that group is a different value proposition than personalized ratings and information alone. One example of an impact Persona (Persona) is the Circular Economist Persona, which includes causes related to waste reduction, sustainable use of resources, and economic justice. It also has associations and meaning as a separate identity based on its use in public media, literature, and non-governmental and activist organizations.

While each Persona represents an existing identity in the public sphere, the Personas have not been organized into a structured analysis and information system for users. As an example, the system can define 130 Personas or more, wherein each Persona reflects causes related to sustainability, social, economic, justice, and/or other goals (e.g., ethical goals) that can be set based on any user's own ideology. The Personas can be designed to encourage individualization (e.g., users recognize themselves in the Persona) and group identification (e.g., users feel a part of a broader group or movement toward similar ethical goals).

The idea of Personas introduces a community and affiliation with other like-minded users. When users care about a cause or set of causes, they typically want others to care about those causes as well, and the users want to be a part of a larger movement in support of those causes. This idea is similar to work in the non-profit and social organizing space that seeks to create a larger impact through coalition-building or a movement in support of a cause, i.e., where the impact is greater than the sum of the efforts of individual actors involved.

The system continuously generates additional information about each Persona. Information that the system provides includes lists of companies, brands, and investments that other users with the same Persona are engaging with (i.e., social proof associated with the user's deeply-held values); links to non-governmental and activist organizations working on issues associated with the Persona; correlations with other systems of personality types; and other values that found typically associated with the Persona (for example, which are more likely to volunteer).

According to some embodiments, the system creates a community around each Persona through user groups and matching services, whereby the system will allow users to join Persona-based groups to exchange information and coordinate with like-minded users.

According to some embodiments, the system can perform data collation and analysis that would not be possible with personalized ratings alone. Studying user behavior at the Persona level provides interesting insights, such as which Persona groups are more likely to engage with certain companies or investments and correlated with geographic, gender, racial, and/or other socioeconomic factors. This data has the potential to be useful for non-governmental organizations, academic researchers, corporations, etc.

Personas also focus on social sharing and visual representation in support of enabling users to participate in and build a movement around the causes they are passionate about. This would not be possible with personalized ratings alone; users need to see themselves as associated with others working toward the same goals, and Personas enable such.

Each Persona has an ever-growing set of information that makes it distinct from other Personas, including the specific mix of causes included, descriptive information about the Persona, top-rated companies and investments for the Persona, and other organizations working in support of the Persona's causes. Personas are used in several ways, including showing users information about their Persona (such as details about the specific causes they are supporting); as well as creating ratings of companies, funds, and portfolios that are specific to each Persona, providing visual reporting about the impact of the user's portfolio on their Persona, and creating community with other users with the Persona.

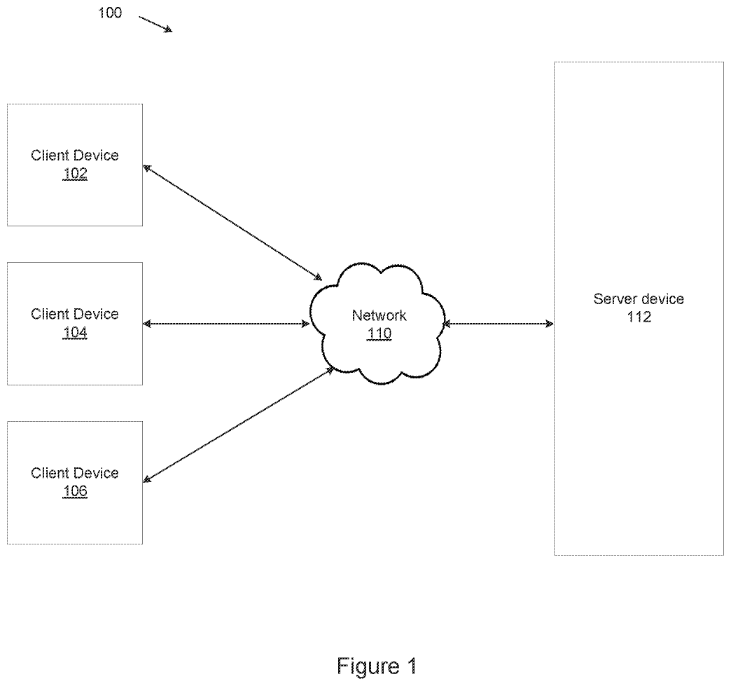

FIG. 1 schematically shows aspects of the example system 100 for personalizing ratings based on an impact assessment to create logical groupings that reflect individual preferences and group identification. That is, a user's particular impact assessment can be input into the system 100, as the system 100 is configured to provide and display a set of user interfaces for user interaction, to receive the user inputs to perform an impact assessment to generate a Persona based on the impact assessment received by the system 100.

The system 100 includes client devices 102, 104, 106, and a server device 112.

Each of the client devices 102, 104, 106, and the server device 112 may be implemented as one or more computing devices with at least one processor and memory. Example computing devices can include a mobile computer, a desktop computer, a server computer, or other computing device or devices such as a server farm or cloud computing used to generate or receive data.

In the examples shown, the client devices 102, 104, 106 can be used by users of the system to access the functionality described herein. For instance, the client devices 102, 104, 106 can communicate with the server device 112 through a network 110. The client devices 102, 104, 106 can be programmed to initiate the impact assessment of the preferences of the user by the server device 112, as described further below.

The server device 112 can also obtain data via other input devices, which can correspond to any electronic data acquisition processes (e.g., from third parties through an application programming interface—API).

The server device 112 can be programmed to deliver the ratings and analyses about the ESG impact of various investments offered by a financial advisory firm to its users. For example, in one embodiment, the server device 112 is one or more computers (typically a server farm or part of a cloud computing environment) that facilitate the ratings and analyses provided by the financial advisory firm. In some examples herein, the server device 112 includes information associated with ESG impacts, such as a company, brand, fund, portfolio, and other investments.

The server device 112 can also be programmed to classify the ratings and analyses offered according to the customers' preferences. In the examples described herein, the server device 112 is programmed to analyze the various preferences offered, automatically identify classifications associated with those ratings based upon certain criteria, and use those classifications to generate logical groups that reflect group identifications.

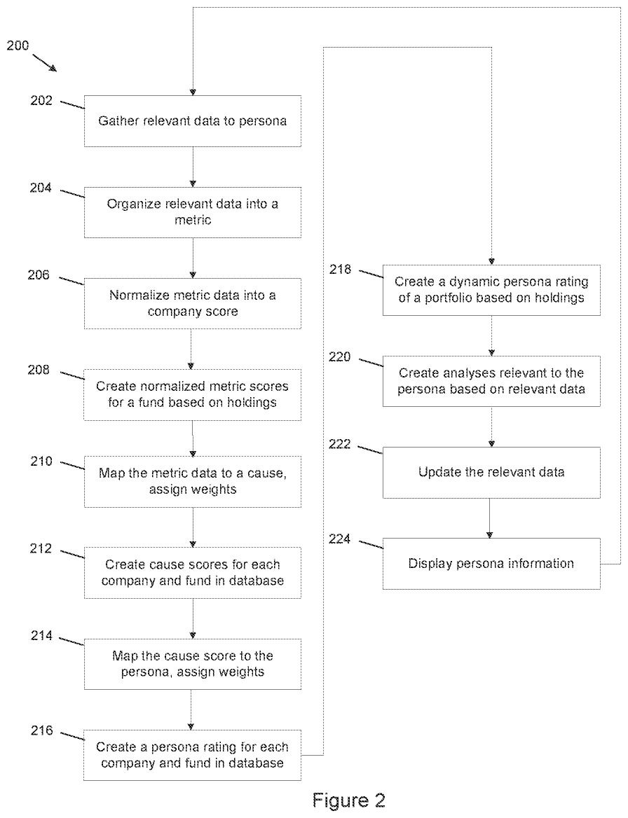

Now referring to FIG. 2, an example method 200 is shown for personalizing ratings based on an impact assessment using the server device 112.

At step 202, data is received by the server device 112. This can be accomplished in various ways by accessing the system 100 described here. For instance, the system can periodically review its aggregated metrics containing relevant data listed in Personas, such as carbon emissions, water withdrawal, employee diversity, employee reviews, government fines received, public controversies, core business models focus, etc.

For example, the metrics “Scope 1 Carbon Emissions” and “Environmental Fines in the Past Four Years” relate to the impact of a company on the environment and global warming.

Data is collected and refreshed on a reoccurring basis following a varying schedule for each metric. For example, company self-reported information is often collected on a rolling annual basis, such as when the company releases its sustainability report. In another example, government fines may produce data quarterly. In yet another example, controversial information may be refreshed weekly, and financial-related information may be refreshed daily.

The system collects data through various formats, including manual data collection, APIs, licensed third parties, and data scraping. Manual data collection is often performed with company information that is self-reported through annual reports or sustainability reports. Various third-party APIs can be used to collect data, such as the company's financial information. Licensed third parties are also a source of collecting data, such as for government fines. Data scraping, also known as web scraping, can import information from a website into a spreadsheet or saved on a local machine. The server device 112 implements a script to monitor and collect information from public sources, such as public information about company-related controversies.

Raw data collected can be stored securely on a cloud. The cloud refers to servers that are accessed over the network 110, and the software and databases that run on the server device 112. The system stores the original format of the data (such as, a PDF document) and converts the data into standard file formats, such as spreadsheets.

When no data is available for a company, the system generates the average of the company's peer group, which is determined through publicly available industry classification systems and company self-reported peers. The system indicates when peer-averaged data is used and presents the percentage of peer-average data for every company and fund aggregated.

At step 204, the relevant data is organized into a metric. For each metric, the system calculates a normalized score ranging from 0-100 for every company covered by the metric. For example, some metrics are only applied to United States companies and large-capital companies with market capitalization of over $10 billion. The system generates both the raw data and the normalized score to be digested by users.

Next, at step 206, the metric data is normalized into a company score. To normalize scores for the metric, the system calculates a Z-score, or a standard score, for each raw data point. The Z-score measures of how many standard deviations a number is above or below the mean. Raw scores above the mean have positive Z-scores, while those below the mean have negative Z-scores.

Depending on the metric, the system calculates the mean and standard deviation for the company's peer group or all aggregated companies. If the metric data varies greatly among industries (e.g., carbon emissions), then the peer group is used as an appropriate population of companies. Alternatively, multiple metrics that compare against a peer group and the total population of companies can also be used.

Where some industries and peer groups have an outsized impact on a metric (e.g., the transportation industry on carbon emissions), the system applies a materiality factor to the Z-score of the companies in that industry and peer group. For example, the transportation industry may have a materiality factor of two for carbon emissions metrics, meaning that the Z-scores of transportation companies are multiplied by two. Doing so increases the company's normalized score relative to other companies if that company scored above average. Conversely, the company's normalized score may decrease if the company performed below average.

The materiality factor is used to provide further weight to companies that are in high-impact industries for a particular metric. Companies are rewarded for making outsized positive contributions to improving a metric, and conversely, companies receive lower ratings when making an excessive negative contribution to the metric.

Most Z-scores are in the range of three standard deviations, plus or minus. To translate this to an approximate 0-100 scale, each Z-score is multiped by 16.667, i.e., translating one standard deviation to a value of 16.667, and then adding 50 to each Z-score, thereby moving the mean of all data points to 50.

As a result, most data points will fall in the range of zero (negative three standard deviations) to 100 (plus three standard deviations). To combat outliers, the system winsorizes all scores at three standard deviations plus or minus, i.e., a minimum score of zero and a maximum score of 100. Winsorizing is the transformation of statistics by limiting extreme values in the statistical data to reduce the effect of possibly spurious outliers.

For metrics that include “Best of” and “Worst of” type ranking lists with fewer than one hundred companies, the system digests the lists as including companies to rate highly (i.e., “Best of” lists) or poorly (“Worst of” lists) relative to companies not on the list. To account for such metrics, the system generates a distribution from 60-100 (“A” and “B” scores) for companies making a “Best of” list or from 0-40 (“D” and “F” scores) for companies making a “Worst of” list because those companies were uniformly measured as not good enough not to be featured on the list. Because the process skews the additional distribution of performance among companies not featured, these metrics are usually given a small weight in calculating final company ratings.

For metrics where raw data has already been distributed on a 0-100 or equivalent scale (e.g., 0-5 scale), the normalization process is skipped, and instead, raw data is multiplied to convert to the 0-100 scale (e.g., multiply data on the 0-5 scale by 20). Further, normalizing the raw data may skew the intended distribution scores from the raw source.

The goal of each normalization strategy is always to maintain the original data's presentation of company performance as best as possible and to aggregate data points into the most accurate view of company performance possible.

The system tests all normalization strategies for each metric to assess which strategy accurately represents the distribution of company performance for that dataset. The system interprets the relationship among companies (e.g., whether data is clustered around a certain range) and at external, absolute gauges of company performance, such as whether there is a credible third party that says the best-performing company for the gender pay gap equality should only be a “B” or “C” level. The system uses these assessments to determine the best normalization strategy for each dataset.

Next, at step 208, normalized metric scores from 0-100 are created for funds based on holdings. Using the weighted average of the underlying holdings, the system produces 0-100 normalized metric scores for every aggregated fund. The weighted-average scores for stock-based funds and funds of funds are calculated for every metric. Stock-based funds do not hold other funds, whereas funds of funds may hold additional funds. Every metric has a calculated mean and standard deviation. A Z-score for every fund has a set mean of 50 and an assigned value of 16.667 for one standard deviation, and a calculated score from 0-100 for every fund, with zero being the minimum and 100 being the maximum.

Next, at step 210, the metrics are mapped to causes and assigned weights. To use the underlying data (i.e., metrics) to create ratings of companies, funds, portfolios, and other investment products, the system maps metrics to each cause and, later on, to each Persona. For example, most of the ESG causes in the system use between 20 and 50 metrics. The system defines weights for each metric such that the sum of metric weights equals 1:

Cause weight=Σ[W_{metric}]

Where W_{metric} is the weight of a metric used to rate a company, fund or portfolio on a cause, and the sum of metric weights equals 1.

For example, the Gender Equality cause may provide 10% weight to the gender pay gap metric, in which case, 10% of a company's gender equality base rating would be composed of its gender pay gap score. To determine an appropriate weight for each metric, the system interprets how relevant the data is to the intended impact area and what measures closely align with the impact area. For example, a company's gender pay gap is more relevant to gender equality than the company's policies on telecommuting.

How credible the data behind the metric and whether it is believed to accurately represent performance at the company or security for the metric are also considered when determining the appropriate weight for each metric, as well as how reliable the data is and if it is consistently reported.

Next, at step 212, a cause score is created for every company and fund aggregated in the system. To create ratings for causes, and later Personas, the system calculates a raw weighted-average score of underlying metrics:

Base score=Σ[W_{metric}×D_{company}]

Where W_{metric} is the weight of a metric, and D_{company} is the raw metric data for a company for the corresponding metric.

The system creates a normalized score from 0-100, following the same normalization logic described above for metrics, along with the raw weighted-average score.

Next, at step 214, the system maps and weighs causes to each Persona. Personas are logical groups of causes that reflect both individual preferences and group identification. For example, the Earth Defender Persona includes causes such as climate action, biodiversity, clean water, and sustainable resource use.

The system employs an underlying hierarchy of potential causes that could be included within the Persona to create Personas. The hierarchy of causes is an evolution from the United Nations Sustainable Development Goals (UNSDG) created by the United Nations to align global action toward sustainable human development for all. The system's hierarchy of causes expands the UNSDG to consider other causes that the system designates users to care about and organize for use in Persona generation.

The UNSDG includes the goals of no poverty, zero hunger, good health, quality education, gender equality, water and sanitation, clean energy, decent work, industry and innovation, reduced inequalities, sustainable communities, responsible consumption, climate action, life below water, life on land, and peace and justice.

The cause categories are the broadest categories of causes defined in the system. The system developed the cause categories to be an easier-to-digest set of causes for users to select. The cause categories include climate action, gender equality, health and well-being, inclusive economies, innovation, life on earth, peace and justice, quality education, sustainable resource use, and water sanitation.

Climate action includes taking urgent action to combat climate change and its impacts. Gender equality includes achieving gender equality and empowerment for all women and girls. Health and well-being include ensuring healthy lives and promoting well-being at all ages. Inclusive economies include creating inclusive economies with no poverty, decent work, and affordable living conditions. Innovation includes innovating to foster economic growth and human development. Life on earth includes protecting biodiversity and ensuring the sustainable use of ecosystems. Peace and justice include promoting peaceful and inclusive societies and providing access to justice. Quality education includes ensuring inclusive and equitable education and promoting lifelong learning opportunities. Sustainable resource use includes ensuring sustainable consumption and production patterns. Water and sanitation include providing availability and sustainable management of water and sanitation for all.

The system defines 35 subcategories of causes based on the UNSDG with additional input regarding gaps in ethical concerns that users may have an interest, such as arts and culture, mental health, and racial justice.

The climate action cause includes the subcategories of disaster readiness and effective aid, reducing greenhouse gas emissions, and renewable energy growth. Disaster readiness and effective aid include being prepared for natural disasters and providing effective aid when disasters happen. Reducing greenhouse gas emissions includes continually reducing greenhouse gas emissions and other pollutants. Renewable energy growth includes increasing access to affordable, reliable, and sustainable energy.

The gender equality cause includes the subcategories of equal pay and opportunity, lesbian, gay, bisexual, transgender, and queer (LGBTQ) equality, and no violence against women. Equal pay and opportunity include achieving equal pay and opportunity for women. LGBTQ equality includes ensuring equal rights for all lesbian, gay, bisexual, transgender, and queer people. No violence against women includes ending violence against women and trafficking.

The health and well-being cause includes the subcategories of access to affordable healthcare, child and maternal health, disease eradication, improving mental health, and reducing tobacco use. Access to affordable healthcare includes ensuring universal access to affordable, quality healthcare. Child and maternal health include ending preventable deaths of mothers and children and supporting reproductive health. Disease eradication includes eradicating infectious and non-communicable diseases. Improving mental health includes supporting awareness and access to mental health support. Reducing the use of tobacco includes the continual reduction of tobacco use.

The inclusive economies cause includes the subcategories of decent and safe work opportunities, fair labor practices, affordable and safe housing, zero hunger, reducing inequality, and no poverty. Decent and safe work opportunities include promoting full and productive employment in safe work environments. Fair labor practices include ensuring fair and humane labor practices. Affordable and safe housing includes ensuring access to affordable and safe housing and living conditions. Zero hunger includes ending hunger and achieving food security. Reducing inequality includes reducing inequality within and among countries. No poverty includes ending poverty in all its forms.

The innovation cause includes the subcategories of the free and secure flow of information and/or technology innovation. The free and secure flow of information includes ensuring a free and open flow of information with secured personal data and privacy. Technology innovation includes fostering technology innovation that supports sustainable economic development.

The life on earth cause includes the subcategories of humane treatment of animals, terrestrial biodiversity, and/or healthy oceans. The humane treatment of animals subcategory includes ensuring the humane treatment of animals. The terrestrial biodiversity subcategory includes protecting biodiversity and wildlife habitats on land, preserving forests, and combating land degradation. The health oceans subcategory includes supporting healthy oceans and marine biodiversity through reduced pollution.

The peace and justice cause includes the subcategories of accountable institutions, racial justice, civil rights, safety from violent conflict, and/or reducing the availability of weapons. The accountable institutions subcategory includes building responsible and inclusive institutions. The racial justice and civil rights subcategory include eliminating racism and ensuring justice. The safety from violent conflicts subcategory includes promoting peace and security for all, including reducing violent conflict. Reducing the availability of weapons includes reducing and controlling access to violent weapons.

The quality education category includes the subcategories of arts and culture access, quality and lifelong education, and quality primary education. The arts and culture subcategory includes supporting arts and culture creation, preservation, and access. The quality lifelong education subcategory includes ensuring access to quality secondary education and lifelong learning opportunities. The quality primary education subcategory includes providing inclusive and quality education for all children.

The sustainable resource use category includes the subcategories of conflict-free mineral production, sustainable use of natural resources, and reducing waste. The conflict-free mineral production subcategory includes reducing violence in the production of minerals. The sustainable use of natural resources includes the sustainable use of natural resources. Reducing waste includes reducing waste and supporting reusable materials.

The water and sanitation category includes the subcategories of clean water access, sanitation access, and sustainable use of water. The clean water access subcategory includes ensuring the availability of clean and safe water. The sanitation access subcategory includes ensuring the availability of basic sanitation. The sustainable use of water subcategory includes promoting sustainable management of water.

From the 35 subcategories of the causes, the system combines specific sets of causes into Personas based on what is seen as logical groups that have more meaning when taken together. Each Persona has a specific weight set for each of the 35 subcategories, such that the total weight across the subcategories equals 1. To decide which sets of causes should be grouped, the system creates a table of causes. It combines various causes into groups aligned with popular cause-related ideas and frameworks, such as a circular economy.

As a first step, the system creates a Persona for each of the 35 individual subcategories, with 100% weight dedicated to that cause. These Personas are designed for users who are most passionate about a single cause and want to focus their use of money (as users) on that particular cause. The system is configured to determine how various causes can be combined to form meaningful Personas and sets weights accordingly.

After defining the weights of causes for each Persona, the system builds a proprietary set of data, ratings, analysis, and information around each Persona, including data (i.e., the metrics) related to causes and Personas (e.g., carbon emissions, pay data, and board diversity; impact ratings of companies, funds, and portfolios for every Persona); analyses on specific questions related to causes and Personas (e.g., portfolio carbon footprint, an equivalent number of women hired by a fund or portfolio versus a benchmark); and related information about the Persona (e.g., non-governmental organizations working to support Persona causes, or current events and issues related to the Persona).

Next, at step 216, the system creates a rating for each Persona, using the weighted average of mapped cause scores. From the raw weighted-average score, the system sets a mean of 50 and calculates a standard score (or z-score) for every company and fund. This is similar to the process described above to normalize metric scores:

Normalized score=50+(16.667×Z_{company})

Where Z_{company} is the calculated standard score (i.e., the number of standard deviations that the base score is above or below the mean) for a company for a particular cause.

The system calculates a weighted-average z-score, based in part on a comparison to the total population (i.e., all companies) and in part on a comparison to the peer-group mean. The system defines a company's peer group as the closest set of competitors in business model and market capitalization, using publicly available industry classifications and company self-reported information.

The normalization process also considers industry materiality, i.e., the system determines which industries have an outsized impact on the cause and amplify ratings of companies in those industries positively (e.g., if the company scores better than peers) or negatively (e.g., if the company scores worse than peers).

For example, suppose an airline company scores better on a climate-related cause than its peers. In that case, the system increases the rating of that airline by a small factor since airlines tend to have an outsized impact on climate-related causes. Conversely, if an airline's score is worse than its peers on a climate-related issue, then the system decreases the airline's rating by the same factor.

Industry materiality helps ensure that ratings reflect where the user can obtain the most value on impact. For example, a software company might have low direct greenhouse gas emissions; however, such can also mean that changing its behavior will not move the needle significantly on climate change.

Companies in energy-intensive industries such as transportation, food production, or utilities likely have more significant direct greenhouse gas emissions; however, these companies also have the potential for a larger positive impact on climate change. Applying the materiality factor to these industries increases their score (e.g., if the company performs better than peers) or decreases their score (e.g., if the company performs worse than peers).

Fund Persona Ratings are based on three components: weighted-average scores of holdings, impact approach, and advocacy. The system calculates a weighted-average score for a fund based on its holding. The weighted-average score is the bulk of a fund's normalized rating.

Weighted average score=Σ[W_{holding}×R_{holding}]

Where W_{holding} is the weight of a fund holding, and the sum of weights equals one, and R_{holding} is the rating of the corresponding fundholding for the selected cause.

Some funds take the impact approach of an explicit ESG or impact lens to their selection of holdings, engagement with those holdings, internal management, and public reporting. For example, the system can tag these funds as either light green for ESG or dark green for impact-focused. Impact-focused funds must explicitly seek to positively impact one or more of the UNSDG, such as renewable energy, biodiversity, or social justice.

The system provides ESG funds with a slight boost in their normalized score and impact funds with a slightly more significant boost. The system recognizes many ways to define and weight ESG criteria, and a fund should receive credit for intentionally applying ESG or impact criteria.

The system incorporates an assessment of shareholder advocacy activities undertaken by fund managers. Advocacy activities include voting records on ESG-related resolutions and third-party ratings assessing a fund manager's shareholder engagement.

Next, at step 218, the system creates dynamic normalized Persona Ratings from 0-100 for every portfolio (or any combination of securities) that the users make on the system based on the weighted-average score of portfolio holdings. For example, suppose the user is assigned the earth defender Persona and creates a portfolio on the system. In that case, the system combines the 0-100 ratings of the portfolio's holdings for the earth defender Persona with the weights of each holding to create a portfolio weighted-average score for the earth defender Persona.

The system normalizes portfolio ratings using the weighted average of portfolio holdings, whether those holdings are companies, funds, or other assets:

Portfolio score=Σ[W_{holding}×R_{holding}]

Where W_{holding} is the weight of a portfolio holding, and the sum of the weights equals one, and R_{holding} is the rating of the corresponding holding for the selected cause. Where assets are not rated (e.g., cash), the asset does not affect the portfolio's rating.

Next, at step 220, the system creates analyses to address specific impact-related questions related to Personas, such as the total carbon footprint of a portfolio or the alignment of an investment with one of the UNSDGs.

The system implements the following analyses: overall impact, my causes, UNSDGs, real-world impact metrics, advocacy, screens, controversies, global warming, carbon comparison, carbon footprint, and underlying stocks.

The overall impact analysis presents the portfolio's overall impact on the causes associated with the user, compared to a benchmark. Ratings are from 0 (i.e., the worst) to 100 (i.e., the best) and calculated as the weighted-average rating of portfolio holdings across the causes selected by the client:

Σ[W_{cause}*Σ[W_{holding}*R_{holding}]]

Where W_{cause} is the weight of a cause selected by the user and the sum of cause weights equals one, W_{holding} is the weight of a holding in a portfolio and the sum of holding weights equals one, and R_{holding} is the rating for a portfolio holding.

Causes are set when the user takes the impact assessment on the system. In the assessment, the user selects the causes desired and rates how important each cause is to the user.

The “my causes” analysis presents the impact of a portfolio, fund, or company on each of the causes selected by the user, compared to up to three benchmarks. Ratings for each cause are calculated the same as above, as the weighted-average holdings (or the rating of a single company):

Σ[W_{holding}*R_{holding}]

Where W_{holding} is the weight of a holding and the sum of weights equals one, and R_{holding} is the rating for a holding for the selected cause.

The UNSDGs analysis compares the contribution of a portfolio, fund, or company to selected UNSDGs. The SDGs are global goals designed to be a blueprint for achieving a better and more sustainable future. Ratings for each SDG are calculated with a similar methodology as described above for causes on a 0-100 scale:

Σ[W_{holding}*R_{holding}]

Where W_{holding} is the weight of a holding in portfolio and the sum of weights equals one, and R_{holding} is the rating for a portfolio holding for the indicated UNSDG.

The system creates ratings for each company and fund on the system for each UNSDG following the same methodology described above for causes, i.e., selecting metrics and weights for each SDG, aggregating data for those metrics, calculating weighted-average scores, etc. A higher score indicates a greater contribution to achieving the SDGs, and the system considers exposure to an SDG to be a rating of 70/100 or better. This threshold is designed to indicate contribution to the SDGs significantly above average.

The real-world impact metrics analysis describes the impact of a portfolio, fund, or company in terms of a tangible, real-world impact compared to a benchmark. The system provides more than 20 optional real-world impact metrics. Each metric is calculated using underlying data such as carbon emissions, investments in tobacco companies, or waste generated. For each metric, the system calculates the weighted average for a portfolio's holdings and for selected benchmarks, where up to three benchmarks may be used:

Σ[W_{holding}*D_{holding}]

Where W_{holding} is the weight of a holding in a portfolio or fund and the sum of holding weights equals one, and D_{holding} is the raw datapoint for a holding for the indicated metric, such as carbon emissions.

The system uses the weighted average to calculate the percent that a portfolio or fund is better or worse than the selected benchmarks (i.e., the efficiency of the portfolio or fund):

(D_{portfolio}−D_{benchmark})÷D_{benchmark}

Where D_{portfolio} is the weighted-average data of the portfolio or fund, and D_{benchmark} is the weighted-average data of the one or more benchmarks.

The system then considers a real-world equivalent cost and the value of a portfolio or investment to estimate the real-world impact:

impact=(Vᵢₙᵥₑₛₜₘₑₙₜ÷R_{cost})×e

Where Vᵢₙᵥₑₛₜₘₑₙₜ is the value of the portfolio or investment, R_{cost} is the real-world cost of a single unit, e.g., one wind turbine, e is the efficiency or percent better or worse than the benchmark.

For example, if a portfolio is invested in 50% more renewable energy companies than the benchmark and the portfolio value is $700,000, the system would estimate the impact of one wind turbine built:

1 wind turbine=(700,000÷350,000)×0.5

With regard to the advocacy analysis, companies and funds in a portfolio can affect positive change through advocacy as shareholders and engagement with public policy. The advocacy analysis shows how well a portfolio, fund, or company uses advocacy to effect positive change. The advocacy analysis is calculated based on several factors, including the percentage of votes in favor of ESG-related resolutions by fund managers in a portfolio; publicly available ratings of how well managers of funds in a portfolio engage invested companies on ESG-related issues; and advocacy-related activities by companies in a portfolio.

The system's positive advocacy activities include fund engagement with held companies on ESG issues, company engagement with governments on climate policy, and taking a public stance supporting racial justice. Activities that the system considers negative include actions such as any political lobbying or voting against ESG resolutions at held companies.

The screens analysis shows the percent of a portfolio or fund's holdings that fail selected ESG screens:

Σ[C_{fail}]÷[C_{holding}]

Where C_{fail} is a company in the portfolio or fund that fails the selected screen, and C_{holding} is a company in the portfolio or fund.

According to some embodiments, the system can have approximately 40 screens that users can select from. The screens analysis covers companies held directly as stocks and indirectly through funds. Companies are only counted once across fund and stock holdings. Having a company that fails an ESG screen can be a powerful way to affect change for an active owner, e.g. if the owner holds the company through a fund manager that is actively working to change behavior at the company.

Compared to benchmarks, the analysis shows a portfolio, fund, or company's exposure to controversies such as oil spills and data breaches. The system tracks public controversies associated with already aggregated companies on the database servers, using publicly available data from media sources, government agencies, and non-governmental organizations. The system defines a controversy as a negative story about a company appearing in one or more credible sources.

Based on three factors, the system assigns each controversy a score from one (i.e., being most controversial) to ten (i.e., being less controversial). The first factor is the severity of impact, involving deaths or injuries and significant environmental damage. The second factor is the extent of the impact, such as how widespread the impact was. The third factor is the company's involvement, such as asking if the company was directly involved or negligent about the behavior of supply chain partners.

To calculate the severity of controversies for a fund or portfolio, the system considers the weighted-average controversy scores of fund or portfolio holdings:

Σ[W_{holding}*C_{holding}]

Where W_{holding} is weight of a holding in a portfolio or fund and the sum of holdings weights equals one, and C_{holding} is the controversy score of a portfolio or fund holding.

When investing in a large corporation, it can be challenging to eliminate controversies. Instead, it may be possible to minimize the severity of controversies. The controversy analysis shows the weighted-average severity of controversies for nine categories, from low to severe. For example, the number of severe controversies for each category can be shown in red to indicate further alarm.

The global warming analysis shows a portfolio, fund, or company's global warming potential in degrees Celsius. Through the 2015 Paris Agreement, world governments committed to curbing global temperature rise to well below 2 degrees Celsius above pre-industrial levels and pursuing efforts to limit warming to 1.5 degrees Celsius. This target of 1.5 degrees Celsius is widely believed to be the maximum amount of warming allowed before the worst effects of climate change.

The global warming analysis is calculated as the weighted-average degrees Celsius warming potential of portfolio holdings:

Σ[W_{holding}*C_{holding}]

Where W_{holding} is the weight of a holding in a portfolio or fund and the sum of the holding weights equals one, and C_{holding} is the degrees Celsius warming potential of the holding.

The system calculates the warming potential for every company aggregated in the system's database based on several underlying metrics, including targets, current emissions, current carbon intensity, and historical reduction.

The target metric is forward-looking, science-based commitments to reduce emissions. The system uses targets set through the Science-based Target Initiative, which offers an independent source for companies to validate that their reduction targets are aligned with a 1.5 degree Celsius or 2 degree Celsius future.

The current emissions metric scopes 1, 2, and 3 metric tons of carbon dioxide (CO₂) from the most recent reporting year.

The current carbon intensity metric measures the intensity alignment with global warming projections. The system calculates metric tons of CO₂ per one million dollars in sales and assesses alignment with global warming scenarios from the Climate Action Tracker (CAT). CAT estimates the total amount of global CO2e that can be released per year between now and 2100 to meet 1.5 degrees Celsius and 2 degrees Celsius scenarios. The system combines the data with global gross domestic product (GDP) projections to estimate current average emissions intensities that are aligned with varying warming scenarios.

The historical reduction metric considers historical reductions in CO₂ emissions to help assess whether a forward-looking commitment is credible.

The carbon comparison analysis shows selected carbon metrics for a portfolio and benchmarks. Metrics are calculated as the weighted average of assets held in the portfolio and benchmarks:

Σ[W_{holding}*D_{holding}]

Where W_{holding} is the weight of a holding in a portfolio or fund and the sum of holding weights equals one, and D_{holding} is raw data for the holding.

The carbon comparison analysis includes the carbon metrics of carbon emissions, carbon intensity, emissions change, climate solutions, and global warming potential.

The carbon emissions metric includes weighted-average greenhouse gas (GHG) or CO₂ equivalent (CO2e) scopes 1, 2, and 3 emissions across portfolio holdings and net emissions offset by the company products, such as solar energy.

The carbon intensity metric includes the weighted-average GHG/CO2e scopes 1, 2, and 3 emissions per one million dollars revenue.

The emissions change metric includes the weighted-average historical percentage change in absolute GHG/CO2e scope 1 and 2 emissions.

The climate solutions metric includes the percent of held companies that offer climate solutions, such as electric vehicles or reusable low-emissions manufacturing technology.

The global warming potential metric indicates how well an aligned portfolio is with the 2015 Paris Agreement on climate change mitigation, adaptation, and finance and the degree Celsius of global warming that the portfolio is aligned with.

The carbon footprint analysis includes showing the total metric tons of carbon emissions financed by a portfolio, fund, or company. The carbon footprint analysis calculates the sum of the metric tons of the emissions financed for each holding:

Σ[(V_{holding}÷Vₐₛₛₑₜ)×Eₐₛₛₑₜ]

Where V_{holding} is the value of the holding in the portfolio, Vₐₛₛₑₜ is the total value of the asset, such as market capitalization for companies or net assets size for funds), and Eₐₛₛₑₜ is the total Scope 1 and 2 emissions of the asset.

While the system tracks and models Scope 3 emissions for all companies in the system's database, the system only uses Scope 1 and 2 for the carbon footprint analysis due to several limitations with Scope 3 data. The limitations with Scope 3 data include the lack of standardized reporting methodology by companies; low coverage of companies reporting Scope 3 emissions (e.g., resulting in significant use of modeling); and likely overlap of Scope 3 emissions across company values chains (e.g., double counting across shared customers and suppliers).

The underlying stocks analysis shows companies with the greatest weight in a portfolio or fund, including directly-held stocks and holdings within funds. Each company in a portfolio is calculated as:

Σ[W_{fund}×W_{holding}]+W_{stock}

Where W_{fund} is the weight of a fund in the portfolio, W_{holding} is the weight of the company holding in a fund, and W_{stock} is the weight of the company as a directly-held stock within the portfolio.

Next, at step 222, gathering and updating data is conducted on a reoccurring basis, such as weekly or monthly. The system continuously expands its coverage of companies, adds metrics, adjusts Personas based on evolving data availability, and determines the most prominent and popular ethical considerations.

While data collection occurs continuously, the system integrates new data collected over the previous month. This process involves local data validation and quality control, tagging with the system's unique critical taxonomy, mapping to company databases, uploading formatted files to the cloud, updating data in staging environments, randomizing tests on data quality, and updating data in production environments.

Local data validation and quality control include a system operator reviewing the collected information to ensure accuracy and completeness. The system operator can include a data lead analyst. The tagging of the system's taxonomy includes every metric in the database having a unique key. The system operator tags data for each new metric with the correct unique metric key. The mapping to company databases includes the system operator ensuring the accurate mapping of company-level data points to the master company record in the system's database. The system uses various keys to connect a raw data point with the master company record, including symbols, tickers, a database with unique strings, and other commonly used identifiers. The uploading of formatted files to the cloud includes the system operator creating separately formatted files for each metric with updated data. Files have a standard format, including columns for metric key, date, data, and company-level identifiers. Once the system operator has approved a file, it is uploaded to the system's secure data storage on a cloud platform, such as Amazon Web Services (AWS). Updating data in the staging environment includes a system executing code to pull from the cloud platform and update the metrics in the system's staging environment. The staging environment is a non-live and non-production version of the system that is not accessible to the public. The updating of the production environment includes the system updating the data in the live production environment that is accessible to the public and where updated data replaces previous data.

New data can be made live on a particular business day of each month. Because new data is received, changes to ratings of companies, funds, and portfolios occur once a month, including rating update summaries sent to customers, thresholds, feedback, and live rating updates. In one non-limiting example, new data is live on the first business day of each month, and changes to ratings of companies, funds, and portfolios occur once per month on the tenth day of each month. The changes can be configured to appear on various schedules throughout the monthly, such as daily, weekly, bi-weekly, etc.

Updating summaries for users include the system operator preparing update summaries for users on a monthly reoccurring basis. These summaries include a list of any material rating changes that will occur for companies, funds, and portfolios in the user's account and rationales for the changes. The system sends update summaries to users on a monthly reoccurring basis if the user has opted-in to receive the changes reflected in the update. Users may set thresholds for when to receive update summaries. For example, the user can select a threshold on a portfolio rating based on a change by five or more points. Users can provide feedback in the system during predetermined time frames, such as between the first of the month and the tenth day of the month. The system considers and incorporates feedback as deemed appropriate and, in some cases, where necessary, delays releases of updated ratings. Rating changes are made live on a reoccurring, predetermined date each month, such as the tenth day of each month. The updated ratings replace the previous ratings.

In certain circumstances, such as errors in the calculations of metrics or the input of data used, the system corrects metrics disclosed to users. In such a case, the system releases a relevant announcement to users. In some cases, the system updates data weekly. This is typically the case when major controversies or other news stories warrant a more rapid update. The system operator monitors for controversies and other media stories on an ongoing basis through automated code (such as scraping for controversy and company-related keywords) and manual monitoring.

When a controversy occurs, and the system operator deems it severe enough to warrant an expedited data update, the system updates the controversy data by determining a controversy score, updating the files in the cloud, updating the record in the staging environment, and updating the record in the production environment.

The system determines the controversy score on a scale from one (i.e., most severe) to ten (i.e., least severe), using criteria including the severity of impact (e.g., whether death or injuries are involved), the extent of the impact, and level of involvement of the company.

Updating the files in the cloud includes the system adding the controversy to a master file of controversies, including mapping to the system's database of companies and uploading it to its secure storage in the cloud. The system executes procedures to update the controversy record in the staging environment. After testing the data in the staging environment, the system implements procedures to make the new controversial data live in the production environment. While controversy data may update within a week, ratings for a company with new controversies will still follow the predetermined, reoccurring monthly schedule.

The Personas' qualitative descriptions are based on research of publicly available information about the Persona. For example, the description for the circular economist includes information about how people with this Persona are typically passionate about recycling and reducing waste, are conscientious about the future of the planet, are interested in products such as reusable plastic, and are more likely to bike or take public transportation than their vehicle.

The system implements correlation analyses that look at the likelihood of users in each Persona to fall into other personality types and behaviors, such as hobbies and purchase preferences. The system collects lists of nonprofit and advocacy organizations that support each cause subcategory and each Persona and shares this list with its users as additional opportunities to support the user's preferred causes. For example, the earth defender Personas include organizations such as World Wildlife Fund and the Sierra Club.

Last, at step 224, the user interface displays the results, including Persona information.

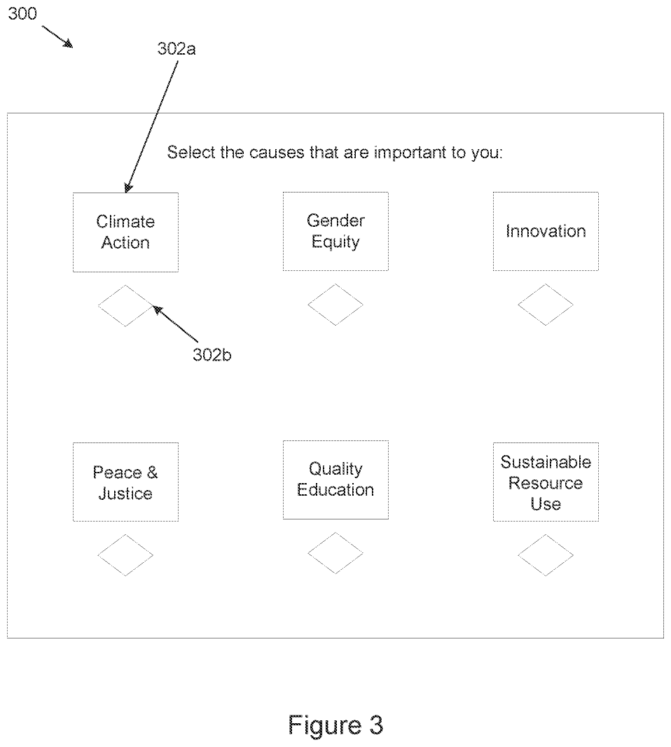

FIGS. 3 through 13 show example series of interfaces for providing a means for a user to input the user's' impact assessment data so that the system can determine the user's Persona based on the data received via the interfaces.

FIG. 3 schematically shows aspects of an example user interface 300 rendered by the server device 112 and/or displayed one of the client device(s) 102, 104, 106. The user interface 300 portraying how Personas are determined and applied to users. The user interface 300 includes selections of cause categories 302a and a selection interface 302b, wherein the user interface 300 receives a user's input as the user interacts with one or more of the selection interface 302b based on the cause categories 302a that the user finds important.

Any individual user, such as an investor or consumer, can discover their Personas through the system's impact assessment, available to the general public. Financial advisors, wealth managers, and other users of the system can share an impact assessment with a client or prospect and capture that user's Persona.

Taking an impact assessment and determining the user's Persona begins by selecting from the cause categories 302a. In one example, interface 300 shows ten cause categories 302a, where the user selects 302b the most important cause category 302a. According to some embodiments, the examples of causes shown in the cause categories 302a are Climate Action, Gender Equity, Health & Well-being, Inclusive Economies, Innovation, Life on Earth, Peace & Justice, Quality Education, Sustainable Resource Use, Water & Sanitation, etc. Other types of categories or different categories can be used and displayed. According to some embodiments, the categories are directed towards one or more social, political, ecological, and/or economic issues.

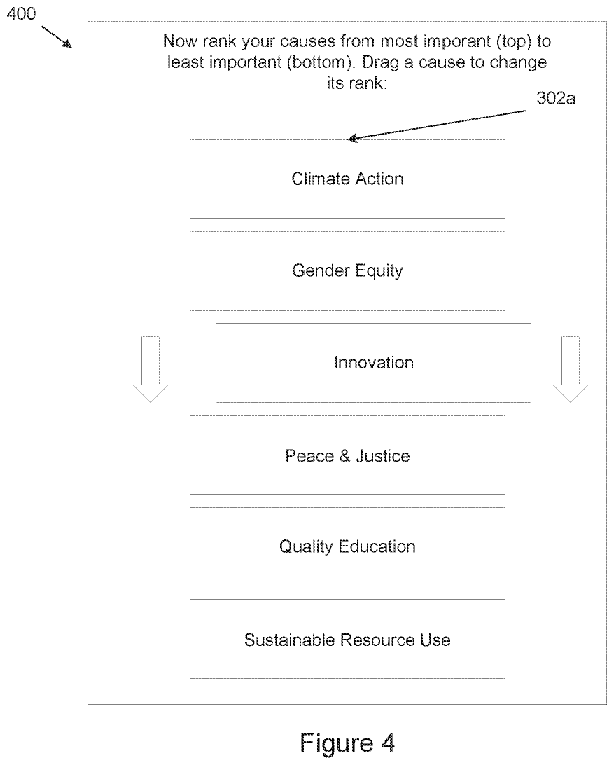

FIG. 4 shows another embodiment of a user interface 400 displayed on a computer device and/or system so that a user can take an impact assessment, wherein the input data gathered from the user interface 400 can be used to determine the user's Persona. The user interface 400 can be used by the user to rank the cause categories 302 by importance according to the user's preference. The user interface 400 provides a ranked set of cause categories 302a, which allows a user to drag and drop the cause categories 302a in the order of importance for the user. The top of the stack of the cause categories 302a having a greater importance than the lower ones.

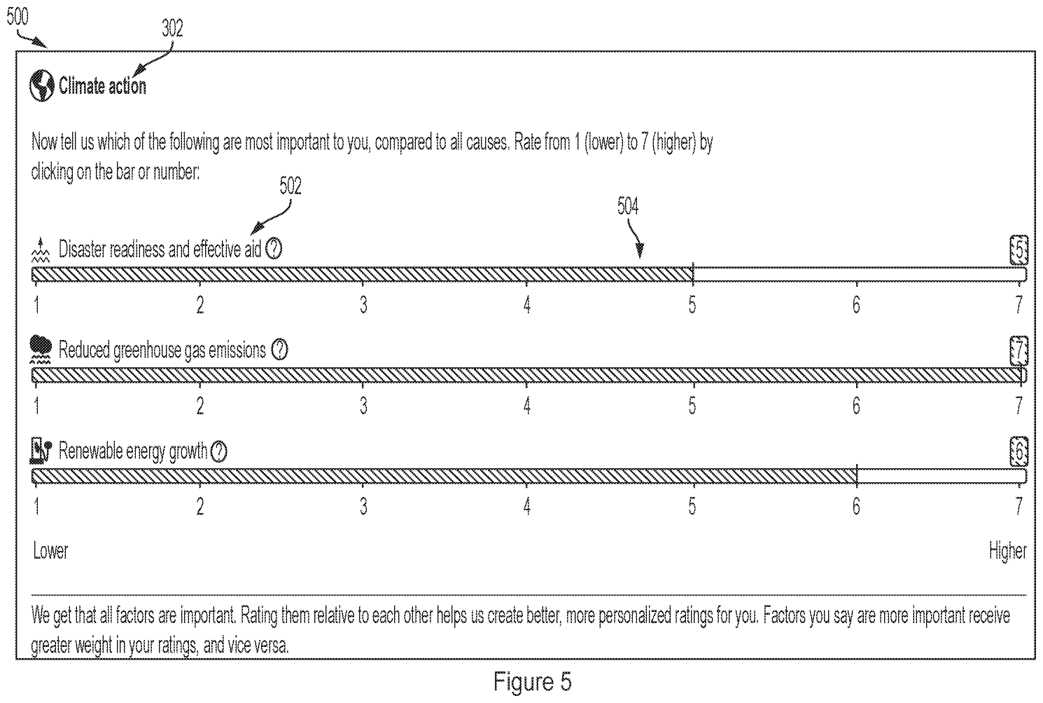

FIG. 5 shows another embodiment of a user interface 500 in the series, taking an impact assessment and determining the user's Persona. Interface 500 rates the importance of cause subcategories 502 including scores 504 within the cause category 302a.

For example, the user interface 500 displays each of the selected cause categories 302a, the user rates their preference for how important each related cause subcategory 502, using a score 504 scale of one to seven points (higher value or point indicating that the subcategory issue is more important to the user). FIG. 5 shows a score of five for the subcategory 502 of disaster readiness and effective aid, a score of seven for reduced greenhouse gas emissions, and a score of six for renewable energy growth subcategory 502.

According to some embodiments, the system 100 uses the preferences indicated on the scores 504 to calculate a best-fit Persona based on determining the total one to seven scores 504 of cause subcategories 502. For example, a six score for reduced greenhouse gas (GHG) emissions, a seven score for renewable energy, a five score for LGBTQ equality, a three score for no poverty, and a four score for mental health added together equal twenty-five total selected scores.

Each of the cause subcategories 502 ratings are converted into a weight, such that the sun of the weights equals one. For example, the reduced GHG emissions score 504 of six is divided by twenty-five equals twenty-four percent, the renewable energy score 504 of seven is divided by twenty-five equals twenty-eight percent, the LGBTQ equality score 504 of five is divided by twenty-five equals twenty percent, the no poverty score 504 of three is divided by twenty-five equals twelve percent, and the mental health score 504 of four is divided by twenty-five equals sixteen percent.

A proportional factor is applied to increase the weight of the cause categories 302 that the user ranks as more important. The closest matching weight of the cause subcategory 502 to find the best-fit Persona. For each of the 134 Personas, the system calculates a matching score by subtracting the weight from the user's selection for each of the 35 cause subcategories 502 from the weight of the Persona's matching cause subcategory 502, followed by summing the differences:

Matching score=Σ[W_{Persona}−W_{Assessment}]

Where W_{Persona} is the weight of a Persona for the cause subcategory 502, and W_{Assessment} is the weight selected by the user for the matching cause subcategory 502.

The system assigns the Persona with the smallest absolute summed difference, i.e., the closest matching Persona.

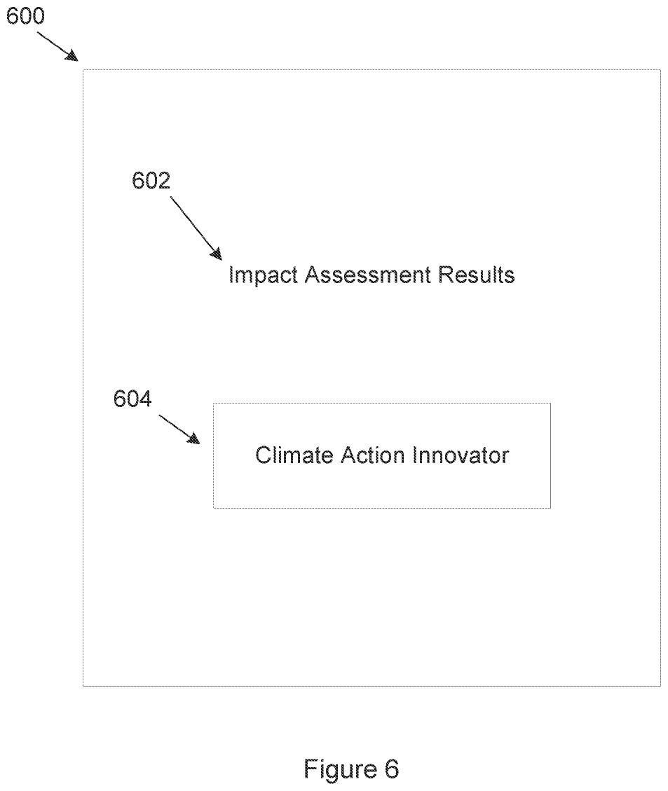

FIG. 6 shows another user interface 600 in the series, taking an impact assessment and determining the user's Persona, showing how Persona information is displayed. Interface 600 displays the impact assessment results 602, including a best-fit Persona 604. After assigning the Persona 604, the system provides immediate information to the user, including a visual representation of the user's Personas. This Persona reflects the causes that the user finds most important, and the system can use this to provide a personalized impact ratings of investments, brands, and/or people. In the example screen shown in FIG. 6, the system has determined that the user's impact assessment has resulted in a determination that the user's Persona is a Climate Action Innovator.

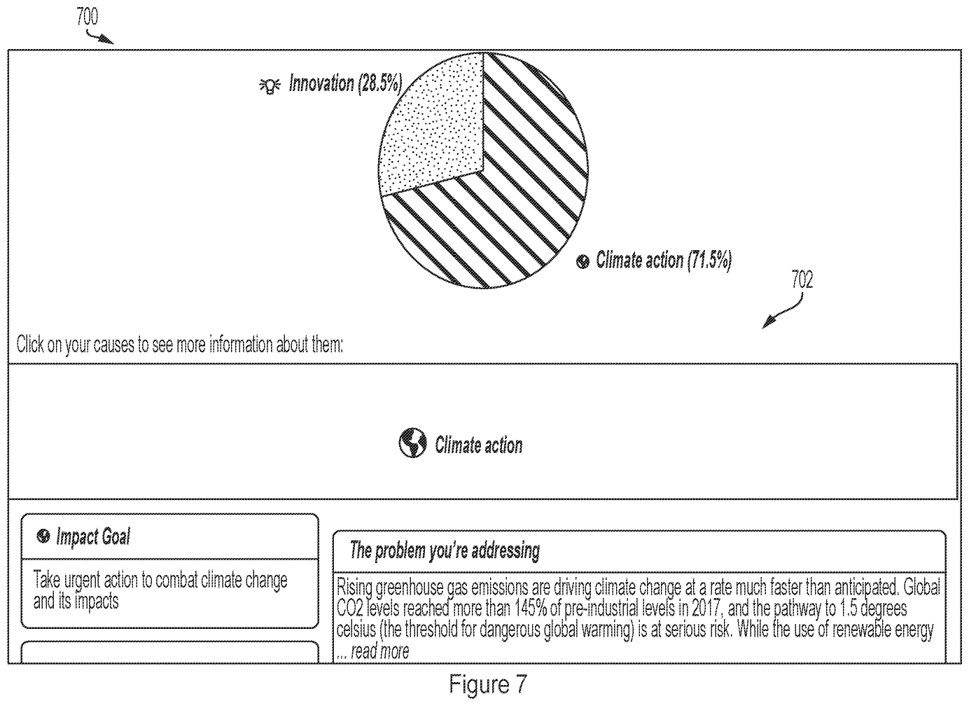

FIG. 7 shows another embodiment of a user interface 700, which can be in the series of user interfaces shown from FIG. 1, taking an impact assessment and determining the user's Persona, showing how Persona information is displayed. The user interface 700 displays the breakdown of the Persona 604 and the descriptive information 702 about the cause subcategories 502 that are included with the Persona 604. For example, the user interface 700 can show a pie chart showing a proportional breakdown of which categories 302a are most important to the user. In the example result screen shown in FIG. 7, the user's Persona was determined based on the user's inputs indicating that 28.5% of the user's important categories were in the Innovation space, while 71.5% of the user's inputs indicated that the user's beliefs includes Climate Action categories to be most important. Based on these, the result shown in the user interface 700 provides additional details of what the Persona aims to achieve (impact goals) and the problems the Persona is addressing. This can help the user better understand themselves and others who have a similar Persona.

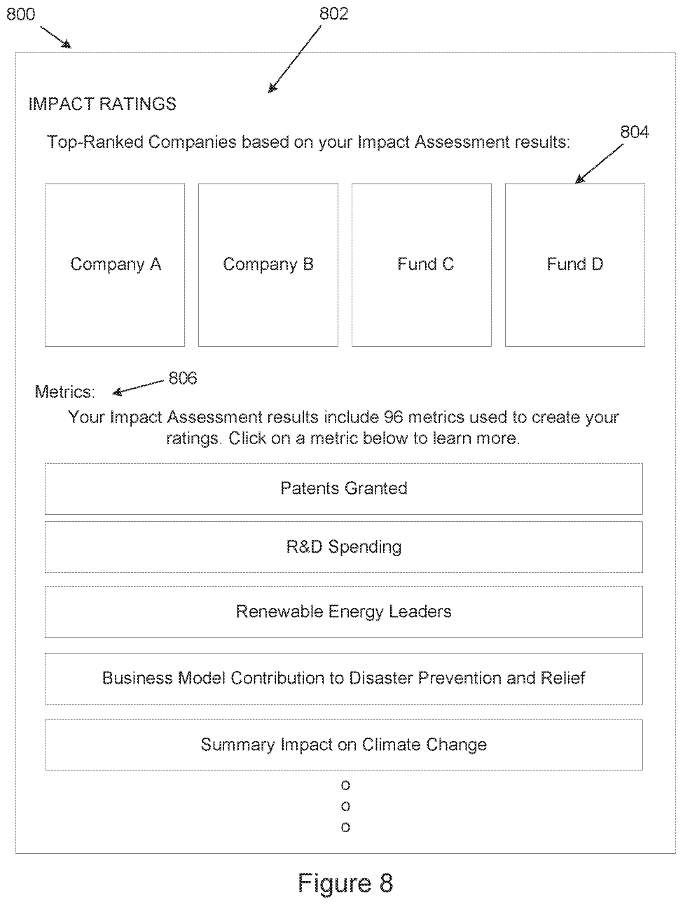

FIG. 8 shows another embodiment of a user interface 800, which can be in a series of interfaces from FIG. 1 according to some embodiments, taking an impact assessment and determining the user's Persona, showing how Persona information is displayed for users. The user interface 800 displays impact ratings 802 of companies and funds 804 for the user's Persona 604 so that the user can immediately see which companies or funds align with their Persona 604, including metrics 806. The metrics 806 can include, for example, patents granted, research and development spending, renewable energy leaders, business model contribution to disaster prevention and relief, and/or summary impact on climate change. The metrics 806 can include other data and/or information, which for example can be accessed by interacting with the user interface 800. These other metrics can also indicate how they support any one or more of the companies and funds 804 being ranked high (or low) for being matched with the Persona 604 based on the Impact Assessment.

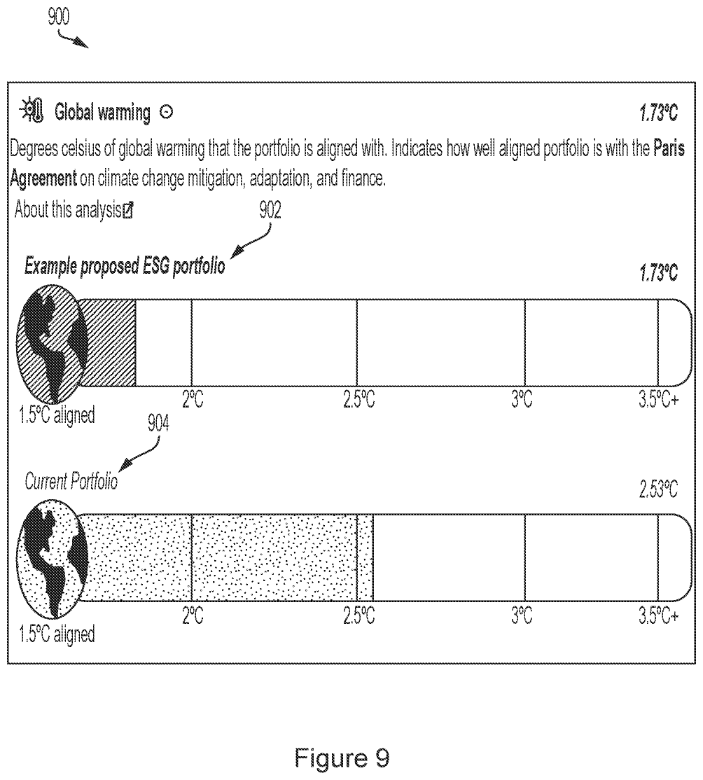

FIG. 9 shows another embodiment of a user interface 900, which can be in a series of interfaces from FIG. 1 according to some embodiments, based on an Impact Assessment and determining the user's Persona. For example, the user interface 900 shows how a Persona information can be displayed for users. The user interface 900 is configured for allowing users to interact with and to display detailed analyses and report for different Personas 604. For example, a financial advisor could show analyses related to global warming and carbon usage to an investor that has a Persona 604 which is related to environmental causes, including an example proposed ESG portfolio 902 and a Current Portfolio 904 held by the investor. The Global Warming metric shown in FIG. 9, for example, can show in degrees Celsius of global warming that a particular portfolio is aligned with (e.g., with the Paris Agreement on climate change mitigation). For example, the user interface 900 can show how the Example proposed ESG portfolio 902 shown in the user interface 900 is more aligned with the Paris Agreement than the user's Current Portfolio 904. Thus, the user interface 900 can provide additional guidance for the user to consider reevaluating the investment portfolio to be better aligned with the user's Persona.

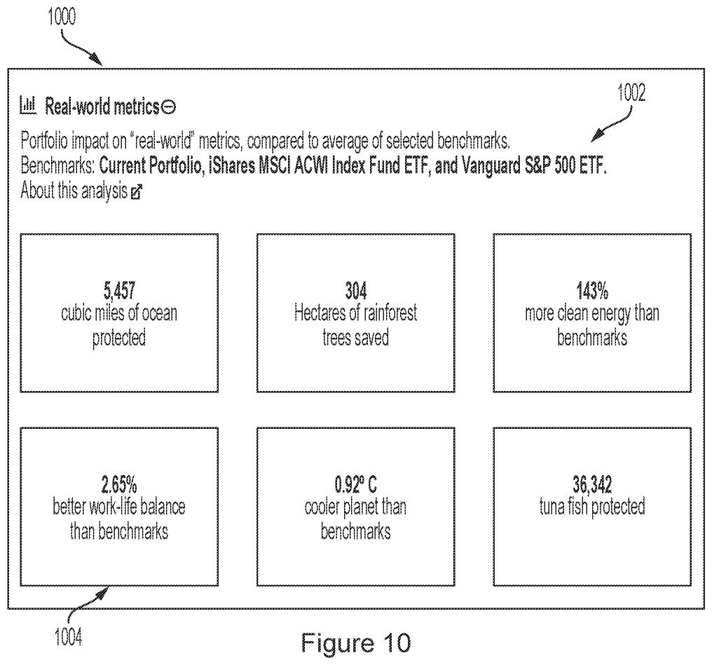

FIG. 10 shows another embodiment of a user interface 1000, which can be in a series of interfaces from FIG. 1 according to some embodiments, taking an Impact Assessment and determining the user's Persona. The user interface 1000 shows an Impact Determination based on the user's Persona and various actions (e.g., investments). The impact Determination is displayed in the user interface 1000, and includes various real-world impact metrics 1004 against various benchmarks 1002. The analysis generates various relative real-world impact metrics 1004 that are more digestible than simply reading the numbers. Thus, the user interface 1000 can provide additional guidance for the user to consider reevaluating the investment portfolio to be better aligned with the user's Persona.

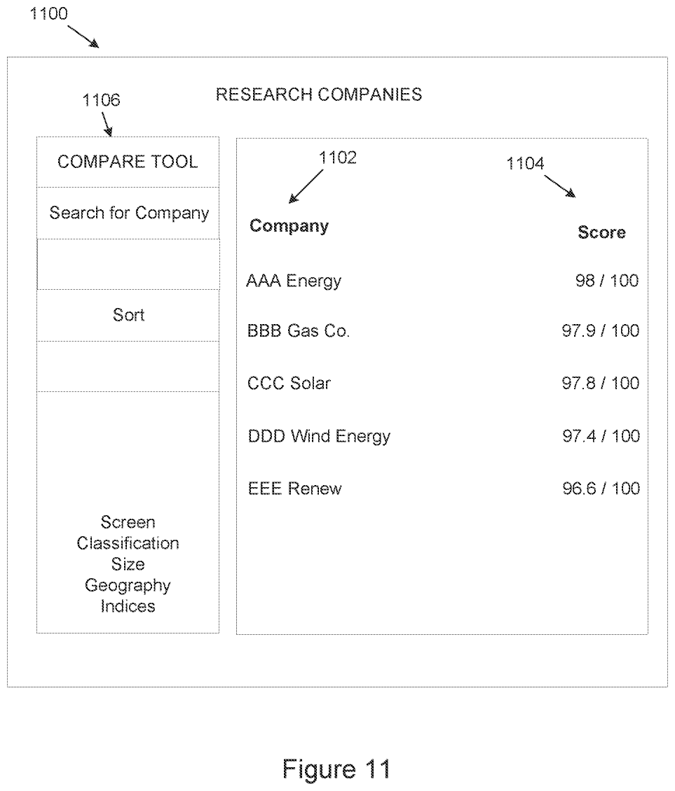

FIG. 11 shows another embodiment of a user interface 1100, which can be in a series of interfaces from FIG. 1 according to some embodiments, taking an Impact Assessment and determining the user's Persona. The user interface 1100 shows how Persona information is displayed for users. For example, the user interface 1100 displays research that the user can perform to discover which companies and investment funds are best aligned with the user's Persona, including a company list 1102, company score 1104, and a comparison tool 1106. The comparison tool 1106 allows for various views of variables to be generated, such as screens, classification, size, geography, and indices. Thus, the user interface 1100 can provide additional guidance for the user to consider reevaluating the investment portfolio to be better aligned with the user's Persona.

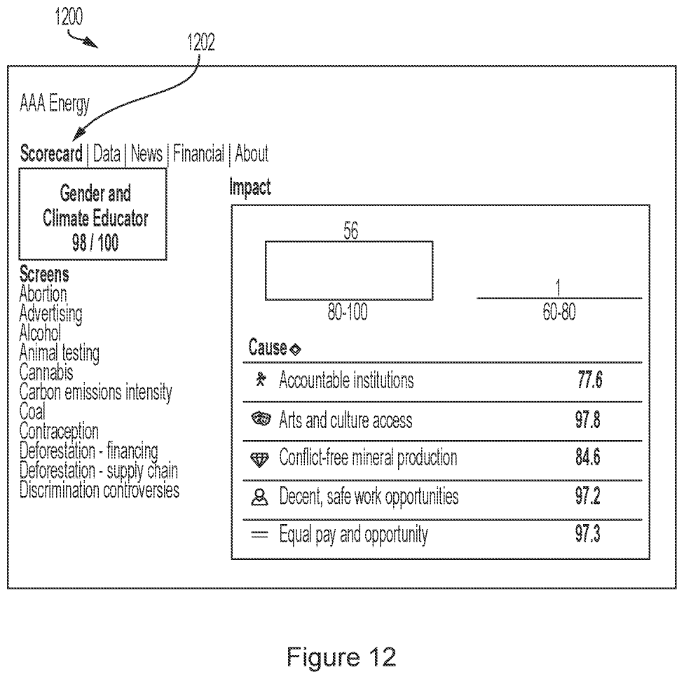

FIG. 12 shows another embodiment of a user interface 1200, which can be in a series of interfaces from FIG. 1 according to some embodiments, taking an Impact Assessment and determining the user's Persona. The user interface 1200 shows how Persona information is displayed. The user interface 1200 displays another view of research results for discovering which companies and investment funds are best-aligned with the user's Persona, including a scorecard 1202. The scorecard 1202 includes various data, news, financial and about the company, and is readily accessible for the user to learn from and make assessments.

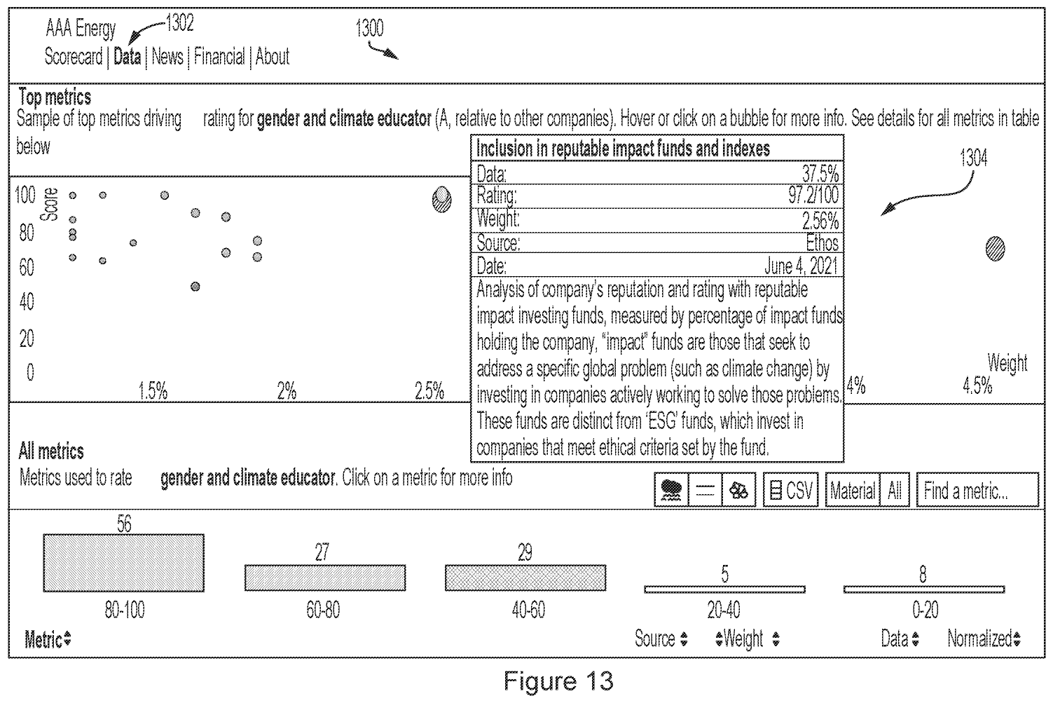

FIG. 13 shows another embodiment of a user interface 1300, which can be in a series of interfaces from FIG. 1 according to some embodiments, taking an Impact Assessment and determining the user's Persona. The user interface 1300 displays yet another view of how the user can research to discover which companies and investment funds are best aligned with the user's Persona view within the data page. The graphical representations include Data 1302 showing descriptive analyses 1304 of various metrics. For example, for the AAA Energy company, the Data 1302 information provides various metrics in a graphical format with various scores determined for the metrics, as well as an Inclusion in reputable impact funds and indexes analytics, with Data, Rating, Weight, Source, and Date information, as well as an Analysis of company's reputation and rating with reputable impact infesting funds, measured by percentage of impact funds holding the company. For example, the “Impact” funds are those that seek to address a specific global problem (such as climate change) by investing in companies actively working to solve those problems. These funds are distinct from “ESG” funds, which invest in companies that meet ethical criteria set by the fund.

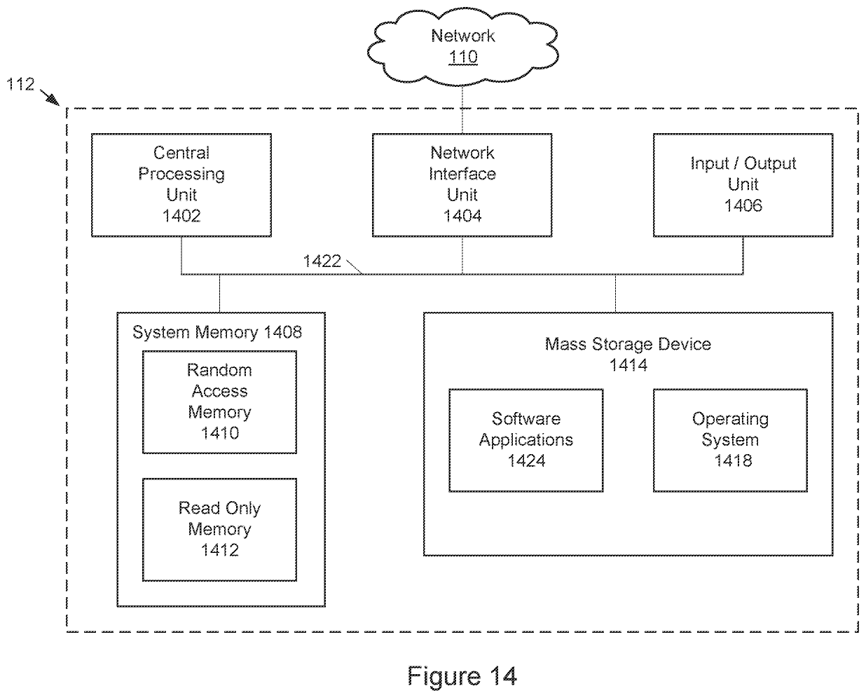

As illustrated in FIG. 14, according to some embodiments, an exemplary server device 112 includes at least one central processing unit (“CPU”) 1402, a system memory 1408, and a system bus 1422 that couples the system memory 1408 to the CPU 1402. The system memory 808 includes a random access memory (“RAM”) 1410 and a read-only memory (“ROM”) 1412. A basic input/output system that contains the basic routines that help to transfer information between elements within the server device 112, such as during startup, is stored in the ROM 1412. The server device 112 further includes a mass storage device 1414. The mass storage device 1414 can store software instructions and data. A central processing unit, system memory, and mass storage device similar to that in FIG. 14 are also included in other computing devices disclosed herein (e.g., devices 102, 104, and 106).

The mass storage device 1414 is connected to the CPU 1402 through a mass storage controller (not shown) connected to the system bus 1422. The mass storage device 1414 and its associated computer-readable data storage media provide non-volatile, non-transitory storage for the server device 112. Although the description of computer-readable data storage media contained herein refers to a mass storage device, such as a hard disk or solid-state disk, it should be appreciated by those skilled in the art that computer-readable data storage media can be any available non-transitory, physical device, or article of manufacture from which the central display station can read data and/or instructions.

Computer-readable data storage media include volatile and non-volatile, removable, and non-removable media implemented in any method or technology for storage of information such as computer-readable software instructions, data structures, program modules, or other data. Example types of computer-readable data storage media include, but are not limited to, RAM, ROM, EPROM, EEPROM, flash memory or other solid-state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the server device 112.

According to various embodiments of the invention, the server device 112 may operate in a networked environment using logical connections to remote network devices through network 110, such as a wireless network, the Internet, or another type of network. The server device 112 may connect to network 110 through a network interface unit 1404 connected to the system bus 1422. It should be appreciated that the network interface unit 1404 may also be utilized to connect to other types of networks and remote computing systems. The server device 112 also includes an input/output controller 1406 for receiving and processing input from a number of other devices, including a touch user interface display screen or another type of input device. Similarly, the input/output controller 1406 may provide output to a touch user interface display screen or other output devices.

As mentioned briefly above, the mass storage device 1414 and the RAM 1410 of the server device 112 can store software instructions and data. The software instructions include an operating system 1418 suitable for controlling the operation of the server device 112. The mass storage device 1414 and/or the RAM 1410 also store software instructions and applications 1424, that when executed by the CPU 1402, cause the server device 112 to provide the functionality of the server device 112 discussed in this document.

The terminology used herein is intended to describe embodiments and is not intended to be limiting. The terms “a,” “an,” and “the” include the plural forms as well, unless clearly indicated otherwise. The terms “comprises” and/or “comprising,” when used in this Specification, specify the presence of the stated features, integers, steps, operations, elements, and/or components, but do not preclude the presence or addition of one or more other features, integers, steps, operations, elements, and/or components. As used herein, the term “based on” is not exclusive and allows for being based on additional factors not described, unless the context clearly dictates otherwise. In addition, the meaning of “in” includes “in” and “on.”

It is to be understood that changes may be made in detail, especially in matters of the construction materials employed and the shape, size, and arrangement of parts without departing from the scope of the present disclosure. This Specification and the embodiments described are examples, with the true scope and spirit of the disclosure being indicated by the claims that follow.

What is claimed is:

1. A computer device, comprising:
a processor; and
a display device in communication with the processor,
wherein the display device displays a user interface,
the user interface includes a set of impact assessment inquiries, and
an input interface for receiving user input,
wherein the user input includes a set of assessment data based on the set of impact assessment inquiries;
the processor, upon receipt of the user input, receives the set of assessment data;
the processor generates an organized assessment data from the set of assessment data;
the processor determines a Persona based on the organized assessment data; and
the Persona is displayed on the user interface.

2. The computer device of claim 1, wherein the processor:
obtains a metric data about a company, fund, and/or investment vehicle;
creates normalized metric score about the company, fund, and/or investment vehicle from the metric data;
maps the normalized metric score to a cause,
creates a cause score for the company, fund, and/or investment vehicle;
maps the cause score to the Persona;
determine a Persona Rating for the company, fund, and/or investment vehicle; and
displays in the user interface, the cause score to the Persona and/or the Persona Rating.

3. The computer device of claim 2, wherein the processor:
determines a real-world impact metric for a benchmark based on the Persona Rating; and
displays in the user interface, the real-world impact metric for the benchmark.

4. A method for determining a Persona based on an impact assessment, comprising:
displaying on a display device of a client device via one or more processors,
a user interface, wherein the user interface is configured to:
display a set of impact assessment inquiries, and
display an input interface for inputting a set of assessment data based on the set of impact assessment inquiries;
receiving, via the one or more processors, the set of assessment data;
generating, via the one or more processors, an organized assessment data from the set of assessment data;
determining, via the one or more processors, the Persona based on the organized assessment data;
storing the Persona on a non-transitory computer-readable storage media; and
displaying the Persona in the user interface on the display device.

5. The method of claim 4, further comprising:
obtaining, via the one or more processors, a metric data about a company, fund, and/or investment vehicle;
creating, via the one or mor processors, a normalized metric score about the company, fund, and/or investment vehicle from the metric data;
mapping, via the one or more processors, the normalized metric score to a cause, wherein a weight is assigned for each of the metric data;
creating, via the one or more processors, a cause score for the company, fund, and/or investment vehicle;
storing the cause score on the non-transitory computer-readable storage media;
mapping, via the one or more processors, the cause score to the Persona;
determining, via the one or more processors, a Persona Rating for the company, fund, and/or investment vehicle; and
storing the Persona Rating on the non-transitory computer-readable storage media; and
displaying in the user interface, the cause score to the Persona and/or the Persona Rating.

6. The method of claim 5, wherein the creating the normalized metric score uses the following formula:
normalized metric score=50+(16.667×Z_{company}),
wherein the Z_{company} is a standard score for a company for a particular cause.

7. The method of claim 6, further comprising:
determining, via the one or more processors, a real-world impact metric for a benchmark based on the Persona Rating; and
displaying in the user interface, the real-world impact metric for the benchmark.

8. The method of claim 7, wherein the determining the real-world impact metric uses the following formula:
real-world impact metric=(Vᵢₙᵥₑₛₜₘₑₙₜ÷R_{cost})×e,
where the Vᵢₙᵥₑₛₜₘₑₙₜ is a value of the company, fund, and/or investment vehicle,
wherein the R_{cost} is a real-world cost of a single unit, and
wherein the e is an efficiency relative to the benchmark.
